(19) United States
(12) Patent Application Publication
(10) Pub. No.: US 2005/0129308 A1
(43) Pub. Date: Jun. 16, 2005

(54) Method, apparatus and program storage device for identifying a color of a displayed item using a non-color indicator

(75) Inventors: Dawn Ashley Comfort, Raleigh, NC (US); Karen Ruth Kluttz, Raleigh, NC (US); Kerry A. Ortega, Raleigh, NC (US)

Correspondence Address: CRAWFORD MAUNU PLLC, 1270 NORTHLAND DRIVE, SUITE 390, ST. PAUL, MN, 55120, US

(73) Assignee: International Business Machines Corporation

(21) Appl. No.: 10/732,550

(22) Filed: Dec. 10, 2003

(51) Int. Cl. G06K 9/00; G06K 9/72; G06F 17/21; G06T 11/00

(52) U.S. Cl. 382/165; 382/229; 382/230; 382/177; 715/501.1; 715/500.1; 345/467

(57) ABSTRACT

A method, apparatus and program storage device for identifying a color of a displayed item using a non-color indicator is disclosed. A non-color identifier is assigned to a color. An item in a display is selected. The system determines whether the selected item matches the color that the non-color identifier was assigned to. The non-color identifier is displayed when the selected item matches the color that the non-color identifier was assigned to, else continue presenting the current display.

### BACKGROUND OF THE INVENTION

1. Field of the Invention

This invention relates in general to computer display systems, and more particularly to a method, apparatus and program storage device for identifying a color of a displayed item using a non-color indicator.

2. Description of Related Art

An application runs on an operating system (OS) by employing an API (Application Program Interface) to exploit the various functions that are available. One such function that handles the output of data to a display unit is a graphics display function, e.g., a video system. Generally, an API provides a set of mathematical functions, commands and routines that are used when an application requests the execution of a low-level service that is provided by an OS. APIs differ depending on the OS types involved, and are normally incompatible. A video system is employed to handle the output provided for a display unit. By applying, for example, VGA or SVGA standards, a video system determines how data is to be displayed and then converts digital signals of display data into analog signals to transmit to a display unit. It also determines what the refresh rate and standards of a dedicated graphics processor are and then converts character and color data, received from an API as digital signals of display data, into analog signals that is thereafter transmitted to a display unit. As a result, predetermined characters are displayed on a screen.

As enhancements have been added to the graphics function, a greater and greater variety of colors has become available for displays. And especially on Web pages on the Internet, a large variety of colors has come to be employed, not only for the design of backgrounds, but also for the characters printed on them. However, a problem of visibility has arisen that makes it difficult for a user to identify such character data. That is, with some background and character color combinations it is almost impossible for a user to identify character data, and accordingly, the user could fail to discern important data. Furthermore, when such character data are mixed in with image data (in graphics), identifying the characters becomes even more difficult. These are serious problems, particularly for a user, such as an elderly person or a color-blind individual, whose color vision is impaired.

There exist a number of international standards for color measurement. The most prominent international standards for color measurement are collectively termed the Commission Internationale D l'Eclairage, or International Commission on Illumination (CIE system). The CIE system is based on the premise that specific perceived colors result from the proper combination of an illuminant or reference light source, an object, and an observer. A useful explanation of the CIE system is provided in “Principles of Color Technology,” Section 2B and 2C, Edition 1981, by Billmeyer and Saltzman. Many systems display a color image as a color value split into red, green and blue (RGB), with the intensity of each color being represented by some numeric range from 0 to 255, for example. Images represented in this way are called usually continuous tone or “contone” images. Contone therefore refers to any process that assigns a range of values to each pixel. An RGB image is typically contone because each of the colors is represented by a range from 0 to 255. The CIE system provides a chromaticity diagram that acts as a standard reference for comparing the CIE standard to other color systems.

In operating systems, as mentioned above, the user may change color schemes. But these changes usually only change the user interface (UI) widgets (i.e., a combination of a graphic symbol and some program code to perform a specific function such as a scroll bar) and not the content. Many application use color to denote something in the user interface, for example, red, yellow, and green to denote a status of a server or storage device. Though using color as the sole indicator of information in the UI is an undesirable design technique, many application developers still do it anyway. For example, visually impaired users, users of monochromatic displays (e.g. PDA5), or user of audio only interfaces (e.g., phone) cannot interact with such designs without further options.

It can be seen then that there is a need for a method, apparatus and program storage device for identifying a color of a displayed item using a non-color indicator.

### SUMMARY OF THE INVENTION

To overcome the limitations in the prior art described above, and to overcome other limitations that will become apparent upon reading and understanding the present specification, the present invention discloses a method, apparatus and program storage device for identifying a color of a displayed item using a non-color indicator.

The present invention solves the above-described problems by presenting a non-color identifier for a selected color. The non-color identifier may include text describing the selected item such as “HOT”, “RED”, etc, or a sound associated with the selected item.

A program storage device in accordance with the principles of the present invention includes operations for providing a non-color identifier for a selected item on a display, the operations comprise assigning a non-color identifier for a color, selecting an item in a display, determining whether the selected item matches the color that the non-color identifier was assigned to and displaying the non-color identifier when the selected item matches the color that the non-color identifier was assigned to, else continue presenting the current display.

In another embodiment of the present invention, a device for providing a non-color identifier for a selected item on a display is provided. The device includes memory for storing data thereon and a processor, coupled to the memory, the processor configured to allow a non-color identifier to be assigned for a color, select an item in a display, determine whether the selected item matches the color that the non-color identifier was assigned to and display the non-color identifier when the selected item matches the color that the non-color identifier was assigned to, else continue presenting the current display.

In another embodiment of the present invention, a method for providing a non-color identifier for a selected item on a display is provided. The method includes assigning a non-color identifier for a color, selecting an item in a display, determining whether the selected item matches the color that the non-color identifier was assigned to and displaying the non-color identifier when the selected item matches the color that the non-color identifier was assigned to, else continue presenting the current display.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 shows a computer or data processing system according to an embodiment of the present invention;

FIG. 2 is a functional block diagram of a system for identifying a color of a displayed item using a non-color indicator according to an embodiment of the present invention;

FIG. 3 illustrates a table that provides status for servers or storage devices;

FIG. 4 is a flow chart of a method for allowing a non-color indicator to be assigned to a color in an application according to an embodiment of the present invention;

FIG. 5 is a flow chart of a method for substituting a color of an item for another color or fill pattern according to an embodiment of the present invention;

FIG. 6 illustrates a table of RGB values that may be implemented in a system according to an embodiment of the present invention; and

FIG. 7 is a flow chart of the method for identifying a color of a displayed item using a non-color indicator according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for identifying a color of a displayed item using a non-color indicator. The present invention converts color values to non-color indicators such as text, sound, etc. to indicate the color of an item when the item is selected. The system may be configured to only convey the non-color indicator for items defined as being meaningful.

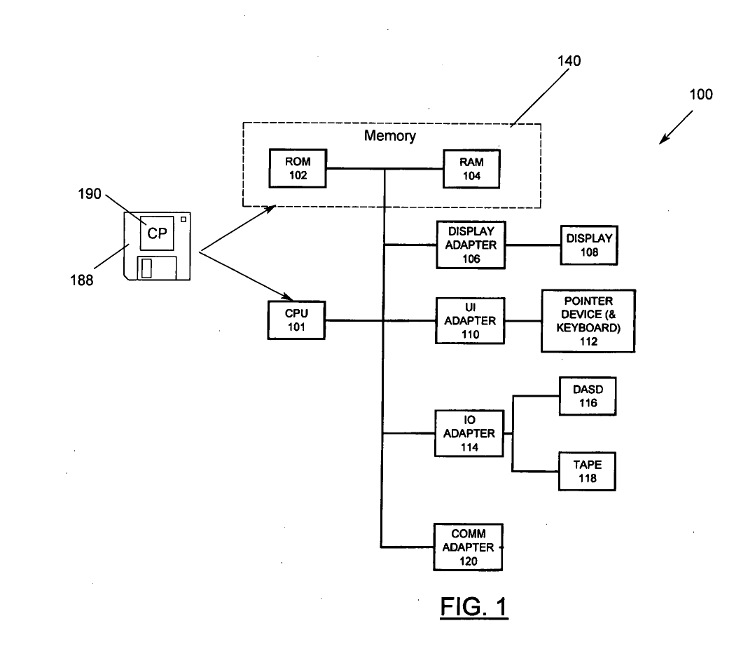

FIG. 1 shows a computer or data processing system 100 according to an embodiment of the present invention. As shown in FIG. 1, computer system 100 includes a central processor unit (CPU) 101, a memory 140, and a display adapter 106 coupled to a display 108. Memory 140 includes a read only memory 102 and a random access memory 104. CPU 101 is coupled to a user interface (UI) adapter 110. The user interface (UI) adapter 110 is coupled to a pointer device and keyboard 112. CPU 101 is also coupled to an input/output (IO) adapter 114. The input/output (IO) adapter 114 is coupled to storage such as direct access storage device (DASD) 116 and tape unit 118. CPU 101 is coupled to communications adapter 120 for providing a communications function.

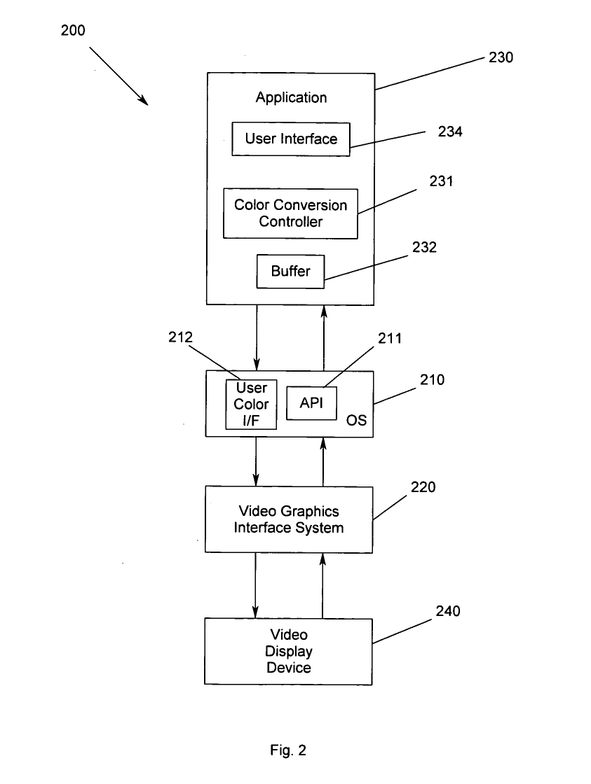

FIG. 2 is a functional block diagram of a system for identifying a color of a displayed item using a non-color indicator 200 according to an embodiment of the present invention. System 200 includes an OS 210, video graphics interface system 220, video display device 240 and an application 230. For example, the application 230 may be a WWW (World Wide Web) browser application, a database program, a photo editor program, etc.

The OS 210 includes an API 211 that provides a set of mathematical functions that can be used by the application 230. The API 211 has functions that can designate a character data address and specify parameters for color elements (R, G, B) in a DAC (Digital To Analog Converter, also called a video DAC) having a color pallet. Thus, the character data obtained by performing a color conversion operation for data in an application can be output via a video graphics interface system 220 to display device 240.

A color conversion controller 231 accesses data from buffer 232. The conversion controller 231 controls a user interface 234 for controlling the input/output of a user. The color conversion system 231 extracts the character data displayed by the application 230, and temporarily stores the character data in the text buffer 232. The conversion controller controller 231 may be used to identify a color of a displayed item using a non-color indicator according to an embodiment of the present invention.

The resultant character data are again displayed on the main application 230. The user interface 234 manages the input and output of a user, so that the start, continuation and halting of the color conversion controller 231 for character data displayed in a window of the application 220 are performed in accordance with instructions received from an input/output controller a user color interface 212, such as a menu bar for a window, a keyboard, a mouse, etc.

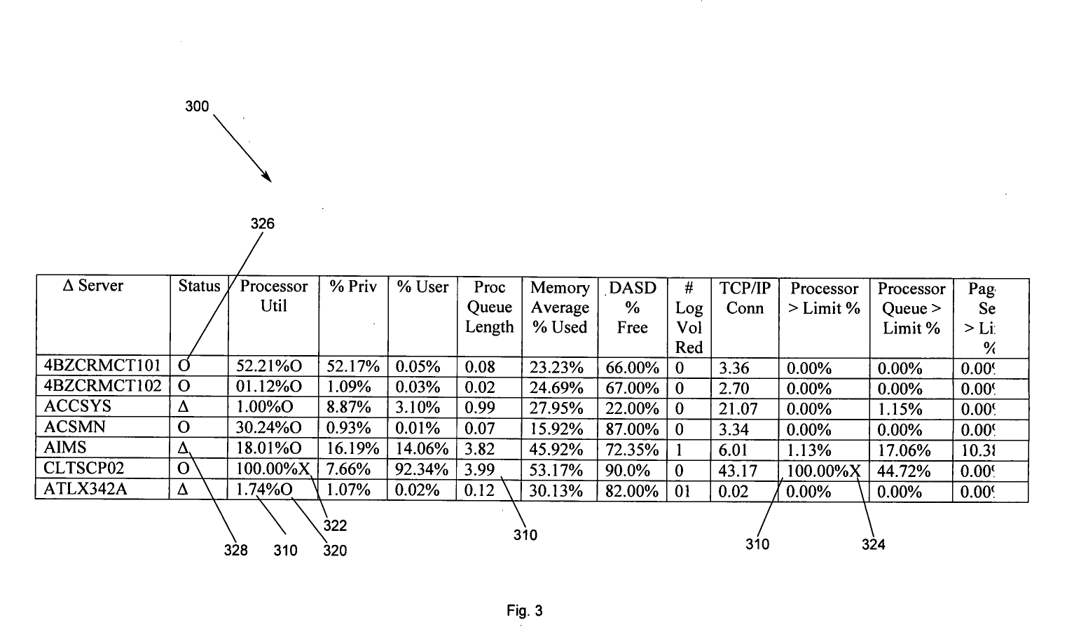

FIG. 3 illustrates a table 300 that provides status for servers or storage devices. The numbers 310 in the table 300 may be represented using different colors to indicate a particular status. In addition to the colored numbers 310, graphic symbols 320-328 may also be provided to indicate the status. These graphic symbols 320-328 add to the clutter of the table 300. However, those skilled in the art will recognize that a table 300 is not the only example of an application that uses color as the sole indication of status. Many applications or web pages use color as the sole indication of status also. For example a red disk might mean a critical problem on a storage device. While the use of color as the sole indicator of a state is a well-known usability problem, designers still make the mistake of using colors as the sole indicator of a state. Furthermore, in some web pages and applications, color may be used just to add color to the UI, but the use of the color has no real meaning in the interface (i.e., the color is gratuitous). Visually impaired users, users of monochromatic displays (e.g. PDAs), or user of audio only interfaces (e.g., phone) cannot interact with such designs.

While some applications will allow the applications interface to be customized, e.g., in browsers the link colors may be changed, some web pages will override the user's choice. Furthermore, such changes would not affect conceptual elements like the color used in status indicators 320-328.

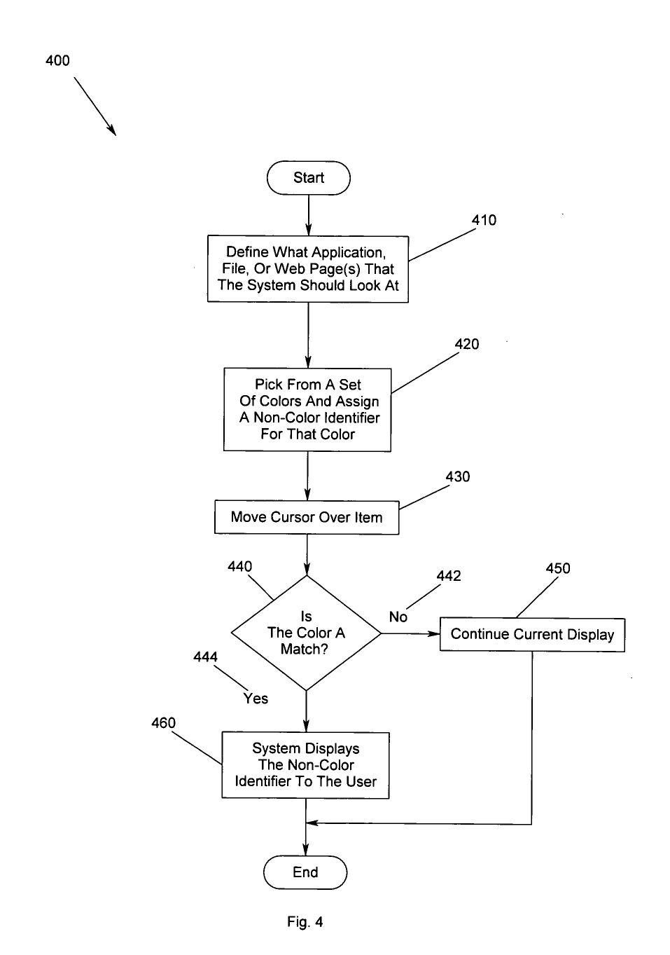

FIG. 4 is a flow chart 400 of a method for allowing the assignment of a non-color indicator to a color in an application according to an embodiment of the present invention. The application, file, or web page(s) that the system should look at is defined 410. For that application, file or web page(s), a set of colors may be selected and a non-color identifier may be assigned such as a text string (it could also be other data like a sound) 420. For example, a text string Hot may be assigned to the background color of red. However, if an identifier is not selected, the system may still use default names for the set of colors. For example, anything close to 255,0,0 i.e., the color red, would default to the text identifier “red”. When the user moves the cursor over or an item is otherwise selected 430, the system checks to see if the color is a match 440. If there is not a match 442, the display does not change 450. If there's a match 444, the system will display the non-color identifier, e.g., text string or other data, to the user 460. For example, a tool tip or “always on top” window may be used. Close matches may be accommodated for as well where the RGB values only vary by some fixed number. The user may also choose to only assign the non-color indicator to “meaningful” colors as described below.

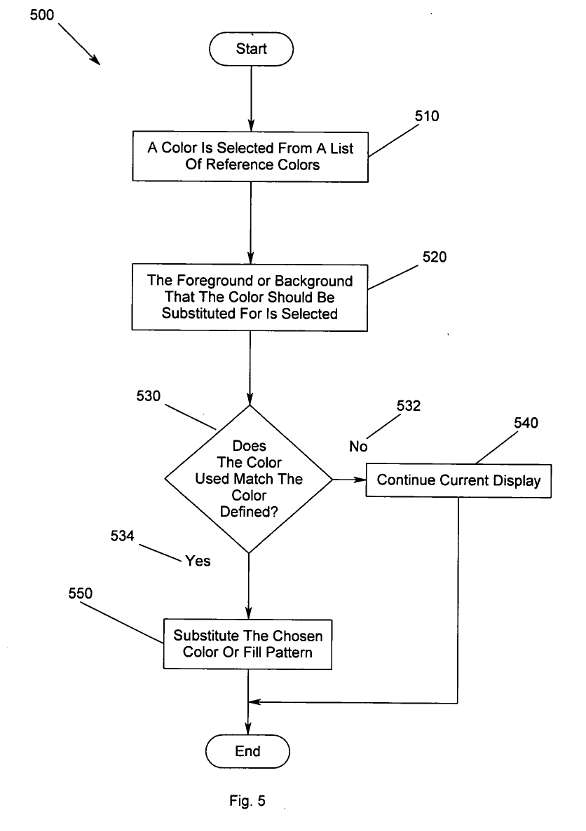

FIG. 5 is a flow chart 500 of a method for substituting a color of an item for another color or fill pattern according to an embodiment of the present invention. The flow chart 500 of FIG. 5 demonstrates how different colors in an interface may be substituted. A list of reference colors 510 may be provided along with whether the foreground or background for that color should be substituted 520. Further, only the “meaningful colors” could be replaced. For example, a new property could be added to the tools that program developers use to create applications or Web pages. The property, set by a programmer during development of the application or Web page, would indicate if a user interface control had a color that was meaningful.” Further, a “meaningfulness” property could be added using a graphical user interface control. Then, a user could point at something on the user interface and through the use of a graphical tool make this item have its “meaningful” property turned on. For example, a user could point at a text box and using a context button (e.g., button 2 on the mouse) bring up a menu that had a “meaningful” property menu item that they could click on. Moreover, for some colors (like the color of a graph) different fill patterns could also be used. This could be for the OS, an application, a particular web page, etc. The system would then be activated.

The system determines if the color used by an application or webpage match the one defined 530. If not 532, the display is not changed 540. If the color is a match 534, the chosen color is substituted for the item selected 550. Again, close matches may be accommodated, i.e., the RGB values varied by some fixed amount. For example say “red”, which has an RGB value of (255, 0, 0), is selected. If the value was (226, 0, 0), the system would still make the substitution to the chosen color or fill pattern.

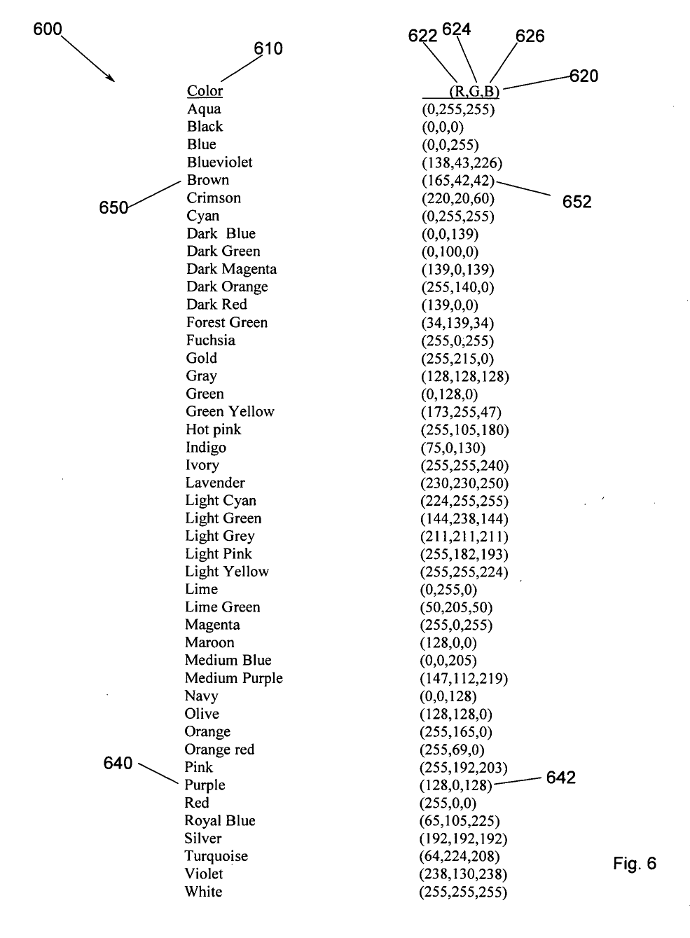

FIG. 6 illustrates a table 600 of RGB values that may be implemented in a system according to an embodiment of the present invention. In FIG. 6, the different colors 610 in the first column are assigned a group of RGB intensity values 620. The RGB intensity values 620 define an intensity for each of the primary colors, red 622, green 624, and blue 626. For example, purple 640 comprises an RGB value of (128, 0, 128) 642 and brown 650 comprises an RGB value of (165, 42, 42) 652.

Referring again to FIG. 2, the color interface 212 is part of an operating system 210 according to an embodiment of the present invention. For example, the color interface 212 may be a part of the accessibility options in Windows 2000. Alternatively, the color interface 212 may be part of an application 230 such as a web browser. The color interface 212 allows a standard color naming set for HTML colors to be mapped to different RGB values as shown in FIG. 6.

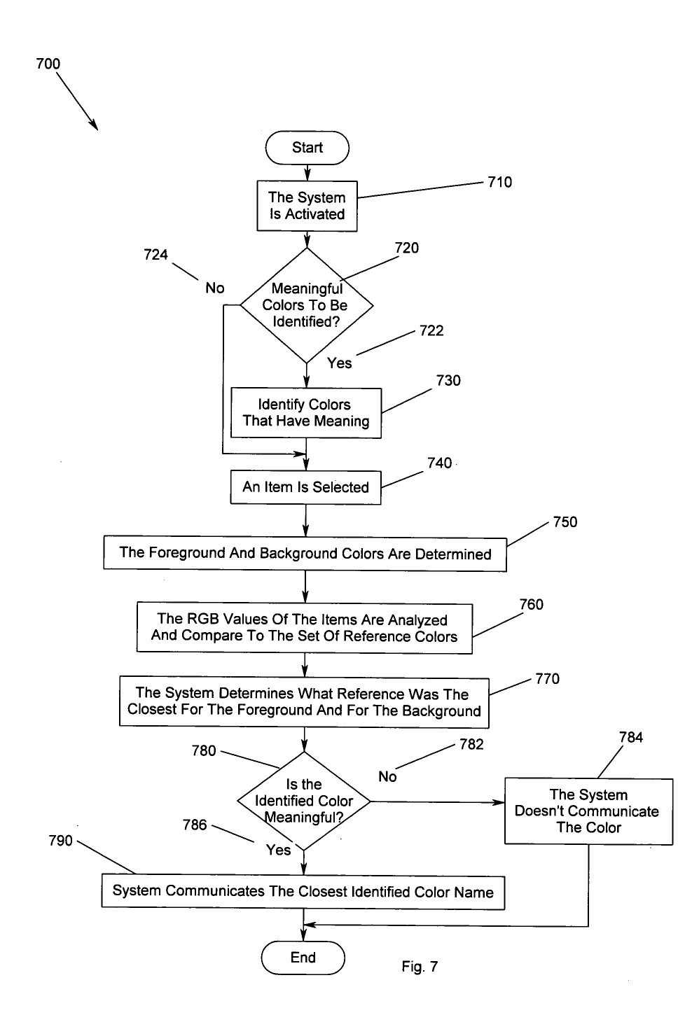

FIG. 7 is a flow chart 700 of the method for identifying a color of a displayed item using a non-color indicator according to an embodiment of the present invention. In FIG. 7, the system is activated 710. A determination is made whether only meaningful colors are to be identified 720. If only colors having meaning are to be identified 722, the colors having meaning are identified 730. Then, an item is selected or the cursor is moved over an item 740. If any colors may be identified 724, an item is selected 740.

The foreground and background colors are determined 750. The RGB values of the item are analyzed and compared to the set of reference colors 760. The system then determines what reference was the closest for the foreground and the background colors 770. The colors are just points in space and simple geometry may be used to determine which reference is closer. This information is presented on a display. There are different ways to present the information, which may include a tool-tip, an “always on top window”, a text to speech playback, or even a sound (in which case different sounds may be assigned to different reference colors). A determination is made whether the identified color is meaningful 780. If the color is not meaningful 782, the system does not communicate the color 784. If the color is meaningful 786, the system communicates the closest identified color name.

The process illustrated with reference to FIGS. 1-7 may be tangibly embodied in a computer-readable medium or carrier, e.g. one or more of the fixed and/or removable data storage devices 188 illustrated in FIG. 1, or other data storage or data communications devices. The computer program 190 may be loaded into memory (not shown) of any of the devices to configure them for execution. The computer program 190 include instructions which, when read and executed by a processor, such as processors 101 of FIG. 1, causes the devices to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A program storage device readable by a computer, the medium tangibly embodying one or more programs of instructions executable by the computer to perform operations for providing a non-color identifier for a selected item on a display, the operations comprising:
assigning a non-color identifier for a color;
selecting an item in a display;
determining whether the selected item matches the color that the non-color identifier was assigned to; and
displaying the non-color identifier when the selected item matches the color that the non-color identifier was assigned to, else continue presenting the current display.

2. The program storage device of claim 1 further comprising defining an application for presenting the non-color identifier in.

3. The program storage device of claim 2, wherein the defining the application comprises defining an application selected from the group comprising a computer software application, a file and a web page.

4. The program storage device of claim 1, wherein the assigning the non-color identifier for a color further comprises indicating whether the color is associated with a foreground or a background.

5. The program storage device of claim 1, wherein the assigning the non-color identifier further comprises assigning the non-color identifier to a color associated with an item, the color associated with the item having a predetermined meaning.

6. The program storage device of claim 5 further comprising determining whether the color associated with a selected item is meaningful.

7. The program storage device of claim 6 further comprising assigning a property defining a color as meaningful using a graphical user interface.

8. The program storage device of claim 6, wherein the displaying the non-color identifier occurs only when the selected item matches the color that the non-color identifier was assigned and when the color associated with the selected item is meaningful, else continue presenting the current display.

9. The program storage device of claim 1, wherein the displaying the non-color identifier further comprises displaying the non-color identifier only when the selected item matches the color that the non-color identifier was assigned to, else continue presenting the current display.

10. The program storage device of claim 1, wherein the determining whether the selected item matches the color that the non-color identifier was assigned to further comprises determining the foreground and background colors associated with the item selected.

11. The program storage device of claim 1, wherein the determining whether the selected item matches the color that the non-color identifier was assigned to further comprises determining whether RGB values for the item selected match the color assigned the non-color identifier.

12. The program storage device of claim 1 1, wherein the determining whether RGB values for the item selected match the color assigned the non-color identifier further comprises determining a closest match for the item selected.

13. The program storage device of claim 12, wherein the determining a closest match for the item selected further comprises determining a reference color closest for the foreground or background color of the item selected.

14. The program storage device of claim 1, wherein the assigning a non-color identifier for a color further comprises assigning a sound to the color.

15. The program storage device of claim 1, wherein the assigning a non-color identifier for a color further comprises assigning a predetermined text string to the color.

16. The program storage device of claim 1 further comprising replacing the color with a fill color.

17. The program storage device of claim 1 further comprising assigning a replacement color for the color.

18. A device for providing a non-color identifier for a selected item on a display, comprising:
memory for storing data thereon; and
a processor, coupled to the memory, the processor configured to allow a non-color identifier to be assigned for a color, select an item in a display, determine whether the selected item matches the color that the non-color identifier was assigned to and display the non-color identifier when the selected item matches the color that the non-color identifier was assigned to, else continue presenting the current display.

19. The device of claim 18, wherein the processor is configured to allow an application to be defined for presenting the non-color identifier in.

20. The device of claim 19, wherein the processor is configured to allow an application selected from the group comprising a computer software application, a file and a web page to be defined.

21. The device of claim 18, wherein the processor is configured to allow an indication of whether the color is associated with a foreground or a background.

22. The device of claim 18, wherein the processor is configured to allow the non-color identifier to be assigned to a color associated with an item, the color associated with the item having a predetermined meaning.

23. The device of claim 22, wherein the processor is configured to allow a determination of whether the color associated with a selected item is meaningful.

24. The device of claim 23 wherein the processor is configured to allow a property defining a color as meaningful to be assigned using a graphical user interface.

25. The device of claim 23, wherein the processor is configured to allow the non-color identifier to be displayed only when the selected item matches the color that the non-color identifier was assigned and when the color associated with the selected item is meaningful, else the processor continues presenting the current display.

26. The device of claim 18, wherein the processor is configured to allow the non-color identifier to be displayed only when the selected item matches the color that the non-color identifier was assigned to, else the processor continues presenting the current display.

27. The device of claim 18, wherein the processor is configured to allow the foreground and background colors associated with the item selected to be determined.

28. The device of claim 18, wherein the processor is configured to allow a determination of whether RGB values for the item selected match the color assigned the non-color identifier.

29. The device of claim 28, wherein the processor is configured to allow a closest match for the item selected to be determined.

30. The device of claim 18, wherein the processor is configured to allow a reference color closest for the foreground or background color of the item selected to be determined.

31. The device of claim 18, wherein the non-color identifier comprises a sound assigned to the color.

32. The device of claim 18, wherein the non-color identifier comprises a predetermined text string assigned to the color.

33. The device of claim 18 further comprising replacing the color with a fill color.

34. The device of claim 18 further comprising assigning a replacement color for the color.

35. A method for providing a non-color identifier for a selected item on a display, comprising:
assigning a non-color identifier for a color;
selecting an item in a display;
determining whether the selected item matches the color that the non-color identifier was assigned to; and
displaying the non-color identifier when the selected item matches the color that the non-color identifier was assigned to, else continue presenting the current display.
